(19) United States
(12) Patent Application Publication
(10) Pub. No.: US 2006/0139244 A1
(43) Pub. Date: Jun. 29, 2006

(54) Method and device for controlling a plasma matrix screen

(75) Inventors: Jean-Raphael Bezal, Grenoble (FR); Jean-Marie Permezel, Grenoble (FR); Gilles Troussel, Grenoble (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics SA, Montrouge (FR)

(21) Appl. No.: 11/315,789

(22) Filed: Dec. 22, 2005

(30) Foreign Application Priority Data
Dec. 23, 2004 (FR) 04 13846
Aug. 25, 2005 (FR) 05 08735

(51) Int. Cl. G09G 3/28

(52) U.S. Cl. 345/60

(57) ABSTRACT

The method is for controlling a plasma matrix screen, including sequential selection of rows of the matrix and, for a selected row, deselection of a plurality of columns of the matrix which were previously selected during the selection of a previous row. To avoid excessive steepness of the falling edges of the column potentials, the previously selected columns are non-simultaneously deselected.

### FIELD OF THE INVENTION

The present invention relates to plasma screens or display panels, and, more particularly, to controlling the cells of such a screen.

### BACKGROUND OF THE INVENTION

A plasma screen is a screen of the matrix type, formed by cells arranged at the intersections of rows and columns. A cell comprises a cavity filled with a noble gas, and at least two control electrodes. To create a luminous point on the screen by using a given cell, the cell is selected by applying a potential difference between its control electrodes then ionization of the gas of the cell is initiated, generally via a third control electrode. This ionization is accompanied by emission of ultraviolet rays. The luminous point is obtained by exciting a red, green or blue luminescent material with the emitted rays.

Controlling a plasma screen conventionally involves essentially two phases, i.e. an addressing phase in which the cells (pixels) to be illuminated and those to be extinguished are determined, as well as a display phase per se in which the cells selected in the addressing phase are actually illuminated.

The addressing phase includes sequential selection of the rows of the matrix. For example, the non-selected rows are set to a resting potential, for example 150 volts, whereas a selected row is brought to an activation potential, for example 0 volt. To select chosen pixels of the selected row, i.e. pixels to be illuminated in the display phase, the corresponding columns of the matrix are for example brought to a relatively high potential, for example 70 volts, via a power stage including power MOS transistors. The columns corresponding to the other pixels of the selected row, which are not to be illuminated, are brought to the 0 volt potential. The cells of the activated row which are to be illuminated therefore experience a column-row potential equal to 70 volts, whereas the other cells of the row experience a column-row potential equal to 0 volt.

This being the case, by applying different potentials to the rows of the matrix in the addressing phase it is also feasible to apply a high potential to a column to select a pixel to be extinguished, and apply a low potential to a column to select a pixel to be illuminated.

International Patent Application WO 02/15163 gives an example of the general operation of such a plasma screen, and focuses in particular on the problem of selecting the columns when a row has been selected. More precisely, this prior art document discusses the problem of the current peak flowing through the power transistors connected to the selected row when a very large number of columns are selected simultaneously (corresponding to a very large number of pixels to be illuminated).

This being the case, another problem has been identified in controlling the cells of a plasma screen, more particularly when deselecting columns which were previously selected, i.e. which have a high potential before their deselection. More precisely, assuming that all the pixels of row i are to be illuminated (or extinguished, depending on the mode of use envisaged) and that all the pixels of the next row i+1 are not to be illuminated (or not to be extinguished, depending on the mode of use envisaged), all the columns of the screen will be selected when row i is selected in the addressing phase, i.e. their potential will be brought to a high state (for example 70 volts). It is then necessary to deselect the columns when the next row i+1 is activated, i.e. make their potential return to a low state (for example 0 volt). This is done by applying a logic signal to a control inverter located on each of the columns, so that one of the power transistors is turned on to make it possible to discharge the capacitance of the cell in question. The column voltage then changes from the value 70 volts to the value 0 by following a falling edge in a given time. Generally, when a column or a small number of columns is or are deselected, the falling time of the column voltage is typically of the order of 100 nanoseconds.

It has conversely been found that when a large number of columns are deselected, for example at least two thirds of the columns of the screen, the falling edges of the respective column voltages become much steeper, i.e. the falling time becomes shorter, for example of the order of 40 nanoseconds. This moreover leads to the emission of additional electromagnetic perturbations which may impair the operation of other components lying in close proximity.

### SUMMARY OF THE INVENTION

It is an object of the invention to limit the electromagnetic emission associated with increasing the steepness of the falling edges and column voltages.

One implementation of the invention thus provides a method for controlling a plasma matrix screen, comprising sequential selection of rows of the matrix and, for a selected row, deselection of a plurality of columns of the matrix which were previously selected during the selection of a previous row. It should be noted here that the previous row may be the row immediately preceding the selected row or an even older row if, for example, no modification was carried out on the columns between this older row and the selected row.

The sequential selection is furthermore a temporal but not necessarily physical selection, in so far as the rows may be selected sequentially according to their consecutive ranks (for example selecting row No 1, then No 2, then No 3, etc.) or not (for example selecting row No 1, then No 3, then No 7, etc.). Lastly, the selection of a column means a column having a potential brought to a high state, whether to illuminate or extinguish the pixel, whereas the deselection of a column means changing its potential from the high state to the low state, whether to extinguish or illuminate a pixel.

According to a general characteristic of this implementation, the previously selected columns are deselected non-simultaneously. In other words, it has been unexpectedly found that an overall action on the deselection times, so as to make them non-identical, provides a solution to the problem of the individual steepness of the falling edges, i.e. makes it possible to avoid influencing the individual duration of the voltage drop too greatly.

According to one implementation of the invention, the deselection of a column comprises the delivery of a deselection signal (the voltage drop) to the column in response to the deselection control signal (typically the application of a control voltage, for example 5 volts, to a control inverter). The phase of deselecting the previously selected columns furthermore includes: simultaneous reception of the deselection control signals intended for the previously selected columns and, in response to the simultaneous reception; and non-simultaneous deliveries of at least some of the deselection signals.

According to one implementation, the non-simultaneously delivered deselection signals are respectively mutually delayed. Although fixed delays may be envisaged, the values of the delays are preferably variable as a function of the number of columns deselected. According to one implementation of the invention, the columns may be deselected by groups of columns, each group including at least one column. Each group is furthermore deselected at a time different from the deselection time of another group.

So as also to resolve the problem of the strong current peak in the supply line when selecting previously deselected columns, according to one implementation it is preferable for the method to furthermore comprise, for a selected row, non-simultaneous selection of a plurality of columns of the matrix which were previously deselected during the selection of a previous row. Here again, the columns may be selected by groups of columns, each group including at least one column and each group being selected at a time different from the selection time of another group.

Another aspect of the invention relates to a device for controlling a plasma matrix screen, comprising a row control circuit capable of sequentially selecting the rows of a matrix, and a column control circuit capable of deselecting a plurality of previously selected columns. According to a general characteristic of this other aspect of the invention, the column control circuit is arranged so as to deselect the previously selected columns non-simultaneously.

According to one embodiment of the invention, the column control circuit comprises individual control blocks respectively connected to the columns of the matrix. Each individual control block is capable of receiving a possible deselection control signal and of delivering a deactivation signal to the column in response. The column control circuit also includes a controller or control means capable of delivering deselection control signals simultaneously to the individual control blocks of the columns to be deselected and an auxiliary unit or means which, in the presence of this simultaneous delivery of the deselection control signals, are capable of causing non-simultaneous delivery of at least some of the deselection signals. These auxiliary means may for example include a delay or delay means, also referred to as auxiliary delay means, capable of respectively mutually delaying at least some of the deselection signals.

According to one embodiment of the invention, each control block includes an inverter, also referred to as the first inverter, having a first terminal connected to a supply voltage, for example 3 or 5 volts, and a second terminal. The auxiliary means include a resistive network, also referred to as the auxiliary resistive network, including resistors, also referred to as auxiliary resistors, connected in series. The auxiliary resistive network is connected between the second terminal of the first inverter of a first control block and the reference earth. The terminals of the various auxiliary resistors are respectively connected to the second terminals of the first inverters of at least some of the individual control blocks. Such an embodiment allows the delays to be made variable as a function of the number of outputs actually deselected.

The column control circuit may also be arranged so as to deselect the previously selected columns by groups of columns, each group including at least one column and each group being deselected at a time different from the deselection time of another group. More precisely, according to one embodiment of the invention, the individual control blocks form a plurality of groups. The second terminals of the first inverters of the individual control blocks of a given group are then connected together and are connected to the second terminals of the first inverters of the individual control blocks of an adjacent group via an auxiliary resistor of the auxiliary resistive network.

According to a variant of the invention, the column control circuit is furthermore capable of non-simultaneously selecting a plurality of previously deselected columns. According to this variant of the invention, the same control circuit can optionally select columns non-simultaneously and deselect columns non-simultaneously.

According to one embodiment, each individual control block is furthermore capable of receiving a possible selection control signal and of delivering an activation signal to the column in response. The control means, for example a shift register associated with latch memories, is furthermore capable of simultaneously delivering selection control signals to the individual control blocks of the columns to be selected, and the device furthermore comprises a secondary unit or means which, in the presence of this simultaneous delivery of the selection control signals, is capable of causing non-simultaneous delivery of at least some of the selection signals.

The secondary means preferably include secondary delay means capable of respectively mutually delaying at least some of the selection signals. The secondary means may include a secondary resistive network including secondary resistors connected in series, the secondary resistive network being connected between the first terminal of the first inverter of a first control block and the supply voltage, and the terminals of the various secondary resistors being respectively connected to the first terminals of the first inverters of at least some of the individual control blocks.

This being the case, it is particularly preferable for the auxiliary means and the secondary means to be defined by the same means. This is because in such an embodiment, the same physical means can be used to select or deselect columns non-simultaneously.

More precisely, and according to an exemplary embodiment using common means, each control block furthermore includes a second control inverter connected in series with the first control inverter, each control inverter having a first terminal connected to a supply voltage and a second terminal connected to the reference earth; the same means then comprise a common resistive network including common resistors connected in series; and the common resistive network is connected between the first terminal of each inverter of a first control block and the supply voltage, the terminals of the various common resistors being respectively connected to the first terminals of the two inverters of at least some of the individual control blocks.

According to another exemplary embodiment using common means, the control means of the column control circuit furthermore comprises latch memories respectively connected at the input of the individual control blocks, and amplification means which are all capable of receiving the same input control signal and of respectively delivering amplified control signals to respectively control the latch memories; each amplification means has a first terminal connected to a supply voltage; the same means comprise a common resistive network including common resistors connected in series, the common resistive network being connected between the first terminal of an amplification means of a first latch memory and the supply voltage, and the terminals of the various common resistors being respectively connected to the first terminals of the amplification means of at least some of the latch memories.

According to yet another exemplary embodiment using common means, the control means of the column control circuit furthermore comprises latch memories respectively connected at the input of the individual control blocks, and a chain of amplification means connected in series which are all capable of respectively receiving input control signals and of respectively delivering amplified control signals to respectively control the latch memories, and the same means comprise the chain of amplification means; the input control signal of a current amplification means starting from the second is the output signal delivered by the previous amplification means.

The column control circuit may be arranged so as to select the said previously selected columns by groups of columns, each group including at least one column and each group being deselected at a time different from the deselection time of another group. More precisely and for example, when the individual control blocks form a plurality of groups, the second terminals of the two inverters of the individual control blocks of a given group may be connected together and connected to the second terminals of the amplification means of the latch memories of an adjacent group via a common resistor of the common resistive network.

According to another possible example, the first terminals of the amplification means of the latch memories of a given group may be connected together and connected to the first terminals of the amplification means of the latch memories of an adjacent group via a common resistor of the common resistive network.

The invention also relates to a plasma screen comprising a plasma matrix screen and a control device as defined above.

### BRIEF DESCRIPTION OF THE DRAWINGS

Other advantages and characteristics of the invention will become apparent on studying the detailed description of entirely nonlimiting embodiments and implementations, and the appended drawings in which:

FIG. 1 is a schematic diagram illustrating a matrix screen according to one embodiment of the invention.

FIG. 2 is a timing diagram illustrating a falling edge of a column voltage during the deselection of a column.

FIG. 3 is a flow chart illustrating the main steps of a method of the invention.

FIG. 4 is a flow chart illustrating a portion of the flow chart of FIG. 3 in more detail.

FIG. 5 is schematic diagram illustrating a more detailed representation of an embodiment of a control device according to the invention.

FIG. 6 is schematic diagram illustrating in detail a part of another embodiment of a control device according to the invention.

FIG. 7 is a timing diagram illustrating the time offsets of the falling edges of the various column voltages of the deselected columns.

FIG. 8 is a flow chart illustrating another method of the invention.

FIG. 9 is a schematic diagram illustrating another embodiment of the invention.

FIGS. 10 and 11 are schematic diagrams illustrating another embodiment of the invention.

FIG. 12 is a timing diagram illustrating various signals for another embodiment of the invention, in particular allowing non-simultaneous selections and deselections of columns.

FIG. 13 to 19 are schematic diagrams illustrating another embodiment of the invention related non-simultaneous selections and deselections of columns.

FIG. 20 is a timing diagram illustrating various signals for another embodiment of the invention.

### DETAILED DESCRIPTION OF THE PREFERRED EMBODIMENTS

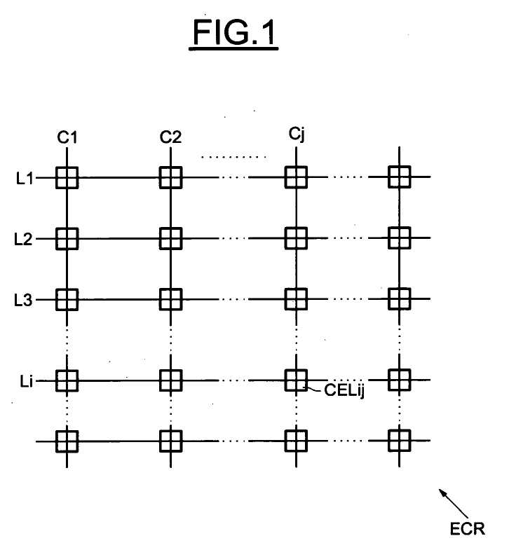

FIG. 1 very schematically represents a structure of a plasma matrix screen ECR formed by cells CELij (corresponding to pixels of the image), each cell CELij having two control electrodes respectively connected to a row Li and to a column Cj. Each cell has an equivalent capacitance of the order of several tens of picofarads. The control device of this screen includes a row control circuit capable of sequentially selecting the rows of the matrix, and a column control circuit capable of selecting and optionally deselecting a plurality of previously selected columns. These circuits are generally integrated on a semiconductor chip.

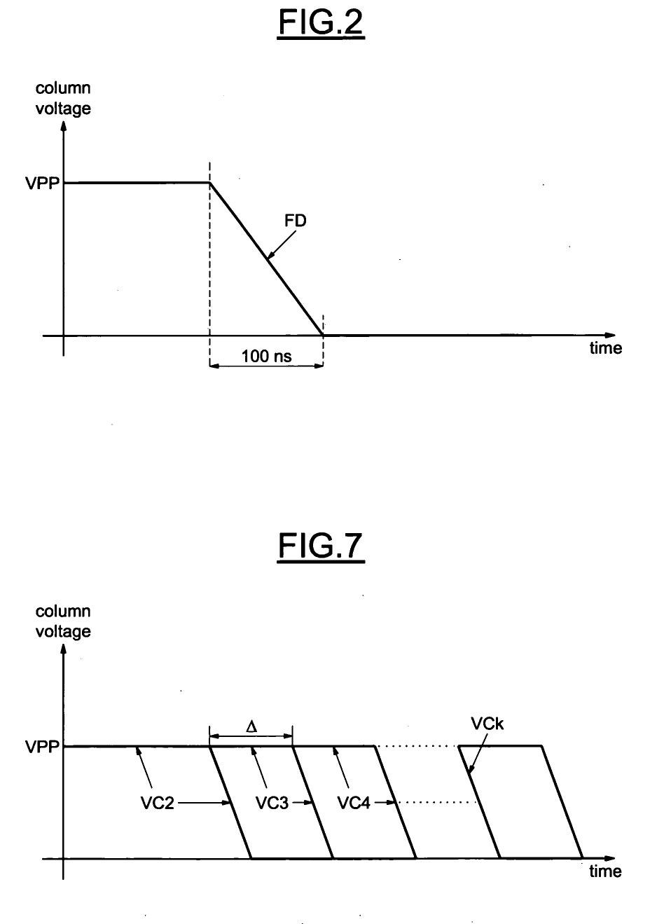

When a column has been selected, its potential is conventionally brought to a high value VPP, typically of the order of 70 volts (to illuminate or extinguish a pixel depending on the mode of use selected for the screen). When a column is to be deselected (to extinguish or illuminate a pixel depending on the mode of use selected for the screen), it is then necessary as illustrated in FIG. 2 to return the column voltage from the value VPP to the value 0 volt, for example. This is done by applying a control logic signal to the individual control block, which in response makes the column voltage drop (this corresponds to discharging the capacitance of the cell) and this entails a falling edge FD which is referred to here as being a column deselection signal.

The duration of this edge is typically of the order of 100 nanoseconds, for example, when one column or a very small number of columns is or are deselected. When a very large number of columns are to be deselected, however, the duration of the front FD is reduced and reaches the value of 40 nanoseconds, for example. This then leads to stronger electromagnetic emissions which may perturb the neighboring components of the screen.

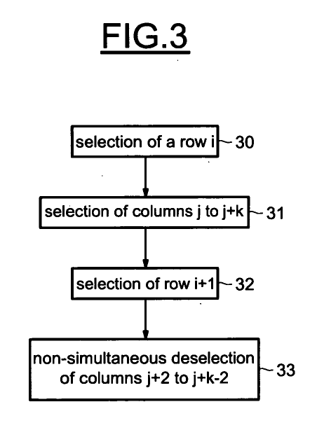

The invention provides a solution to this problem by non-simultaneously deselecting the previously selected columns which are to be deselected. This is illustrated by an implementation of the invention in FIG. 3. More precisely, it is assumed in step 30 that row i has been selected and that, for this row, columns j to j+k have also been selected (step 31). When selecting the next row of rank i+1 (step 32), columns j+2 to j+k−2 have to be deselected. This deselection is then carried out non-simultaneously (step 33).

Clearly, the problem does not arise for the first row of the screen. This is because if this row is to be extinguished (or illuminated, depending on the mode of use selected), the corresponding columns will not be selected, i.e. their potential will remain in the low state. The problem resolved by the invention arises only when, for a row in question, it is expedient to deselect columns which were previously selected during the selection of a previous row, which is not necessarily the row immediately preceding the row in question.

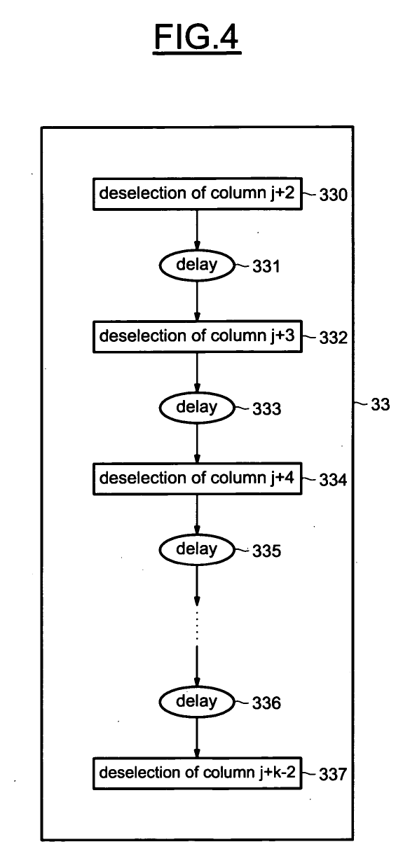

One way of non-simultaneously deselecting the columns consists, as illustrated in FIG. 4, in mutually offsetting their deselection in time by introducing a delay for each column deselection. More precisely, as illustrated in FIG. 4, the deselection of column j+2 takes place in step 330. Column j+3 is then deselected in step 332 with a delay 331 relative to the deselection of column j+2. The same is true for the deselection of column j+4 (step 334) relative to the deselection of column j+3, using a delay 333. Lastly, column j+k−2 is deselected (step 337) with a delay 336 relative to the deselection of column j+k−3.

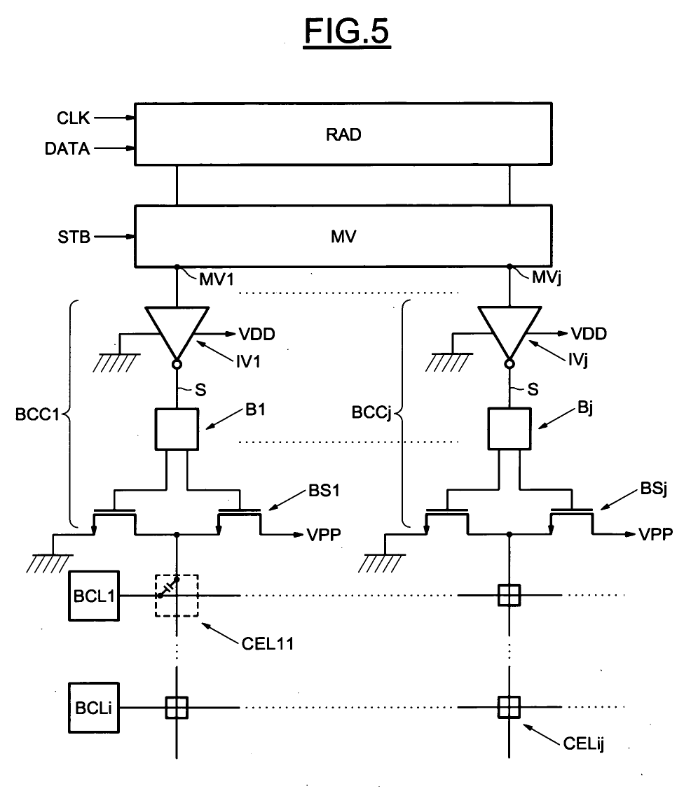

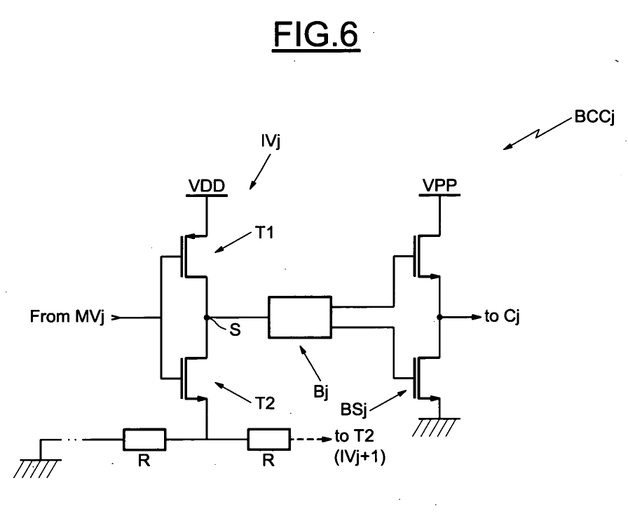

FIGS. 5 and 6 schematically represent an embodiment of the control device according to the invention for implementing the method according to the invention. The row control circuit here includes individual row control blocks BCL1-BCLi, having a conventional structure known per se, which are respectively connected to the rows of the matrix of the screen. The column control circuit includes individual control blocks BCC1-BCCj respectively connected to the columns C1-Cj of the screen.

Upstream of its individual control blocks, the column control circuit also includes a shift register RAD, which is timed by a clock signal CLK and receives the binary data referenced DATA which, in particular, are intended for optionally deselecting columns which were previously selected during the selection of a previous row. The outputs of the shift register RAD are connected to the inputs of a latch memory MV, the respective outputs of which are connected between the individual control blocks BCC1-BCCj. The latch memory MV is controlled by an activation signal STB and will deliver, on its outputs MV1-MVj, the data present at the input of the latch memory MV.

Each individual control block BCCj includes a control inverter IVj whose output S is connected to an intermediate block Bj, which is generally composed of an inverter and a step-up voltage converter. The structure of such a block Bj is conventional and known per se. The output of the block Bj is connected to a power stage BSj, here formed by two NMOS transistors. The gates of the NMOS transistors are connected respectively to two outputs of the block Bj. Furthermore, the source of one of the NMOS transistors is connected to the voltage VPP (of the order of 70 volts) whereas the source of the other NMOS transistor is connected to the reference earth. The other two electrodes of the NMOS transistors are connected together to the corresponding column.

As illustrated in FIG. 6, the control inverter IVj includes, for example, an NMOS transistor referenced T2 and a PMOS transistor referenced T1. The transistor T1 is connected between the supply voltage VDD, for example 3 or 5 volts, and the output S, whereas the gates of these two transistors T1 and T2 are connected to the corresponding output MVj of the latch memory MV. When a previously selected column needs to be deselected, a high logic level, for example 5 volts, is thus applied to the gates of the two transistors T1 and T2, the effect of which is to turn on the earthed power transistor of the power stage BSj and to turn off the other power transistor. The capacitance of the cell therefore discharges, and the column voltage drops from the value VPP to the value 0.

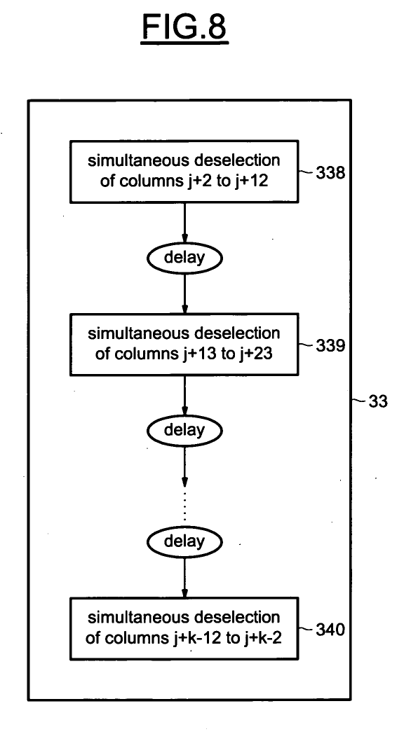

In practice the deselection control signals, i.e. the data present at the outputs of the latch memory MV, are delivered simultaneously to the inverters IVj. A first solution for mutually delaying the column deselection signals, i.e. the appearance of the falling edges FD, consists in producing inverters IVj whose P-type MOS transistors have different width/length (W/L) ratios from one another. This is because the ratio W/L of the P-type transistors determines in particular the current which can flow through this transistor, and therefore makes it possible to adjust the time when the falling edge of the column voltage appears. This leads to the column voltage profiles as illustrated in FIG. 7, where the voltage VC2 of the column C2 drops first of all, followed after a delay Δ by the voltage VC3 of the column C3, and so on.

Another way of mutually offsetting the appearance of the falling edges of the column voltages consists in using the embodiment illustrated in FIG. 6. More precisely, here there is an auxiliary resistive network including auxiliary resistors R connected in series. The auxiliary resistive network is connected between the second terminal (here the source) of the transistor T2 of the inverter IV of a first control block and the reference earth. Furthermore, the terminals of the various resistors are respectively connected to the sources of the transistors T2 of the various inverters IVj.

This preferred embodiment is particularly advantageous because it makes it possible to produce delays which are variable as a function of the number of columns deselected. This is because the delay introduced by an inverter IVj depends on the voltage drop in the auxiliary resistors R, and these voltage drops depend on the number of outputs which switch, i.e. the number of columns deselected. Thus, the higher is the number of outputs which switch, the longer is the switching time of the inverters.

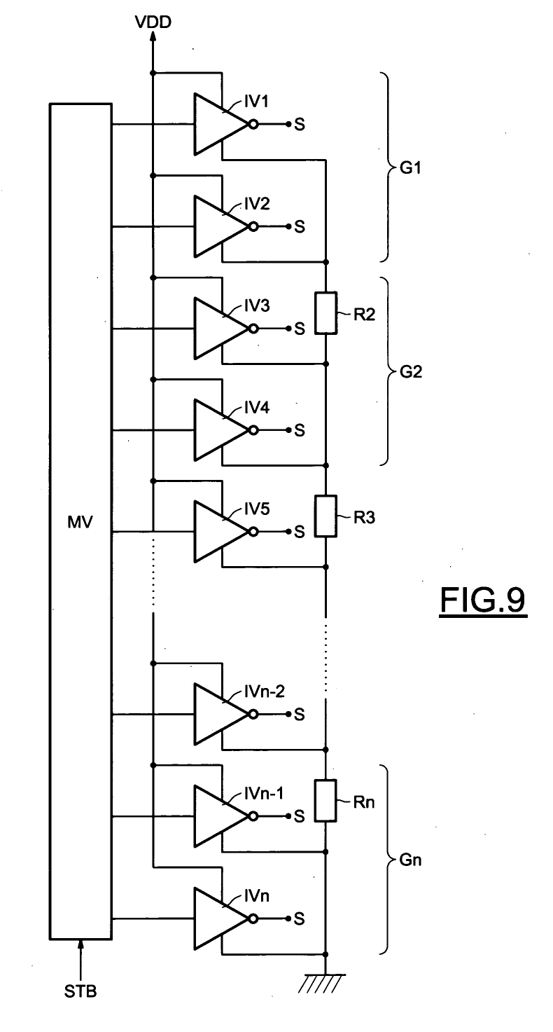

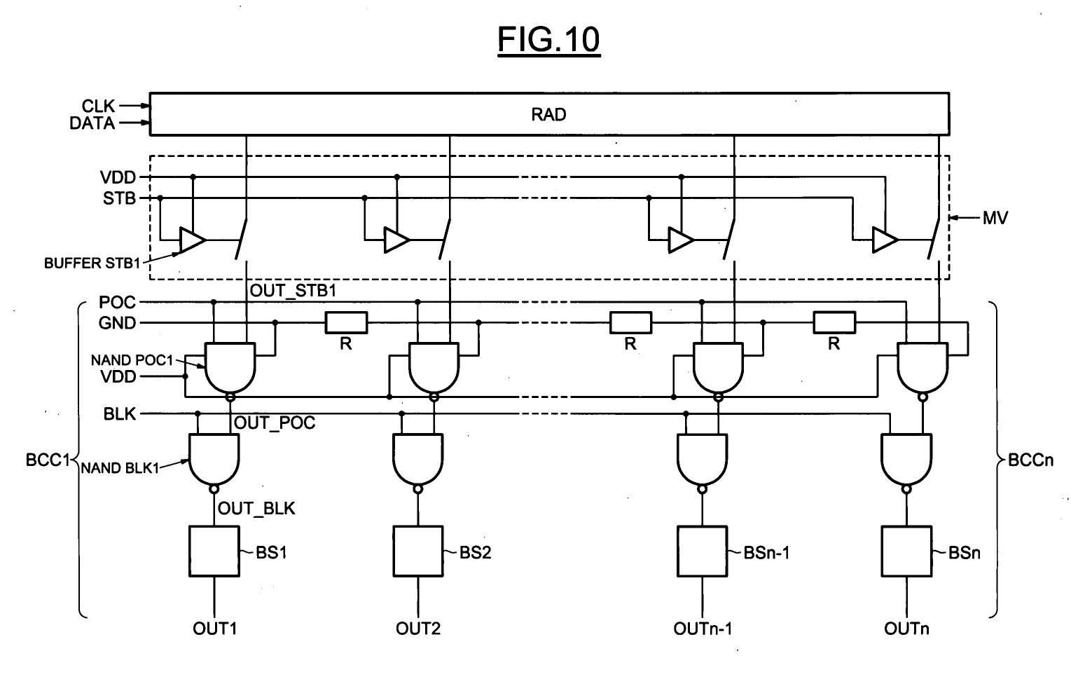

The non-simultaneous deselection of the columns to be deselected may be carried out column by column or by groups of columns, as illustrated in FIG. 8 and FIG. 9. More precisely, it may be envisaged that in the step 33 of non-simultaneously deselecting the columns (FIG. 8), columns j+2 to j+12 are deselected simultaneously (step 338) and that columns j+13 to j+23 are deselected simultaneously (step 339) but with a delay relative to the simultaneous deselection of columns j+2 to j+12. Likewise, the deselection of columns j+k−12 to j+k−2 (step 340) is carried out simultaneously but with a delay relative to the simultaneous deselection of the previous group of columns.

FIG. 9 illustrates another embodiment of a control device according to the invention, which allows non-simultaneous deselection by groups of columns. This FIG. 9 shows the auxiliary resistive network formed here by auxiliary resistors R2, R3, Rn. The individual control blocks form a plurality of groups, here the groups G1, G2, Gn. Each group is formed in this example by two individual control blocks, illustrated in FIG. 9 by the two control inverters. All the first terminals of the inverters are connected to the supply voltage VDD.

All the second terminals of the inverters are connected to the reference ground via the auxiliary resistive network. Furthermore, the groups are mutually separated by an auxiliary resistor of the auxiliary resistive network. More precisely, in this example the first group G1 formed by the inverters IV1 and IV2 is arranged so that the second terminals of the inverters IV1 and IV2 are connected together to a first terminal of the resistor R2.

The second group G2 formed by the inverters IV3 and IV4 is arranged so that the second terminals of these two inverters are connected together, as well as to the second terminal of the resistor and to the first terminal of the resistor R3, which separates this second group G2 from the third group G3. Lastly, the resistor Rn separates the group Gn−1 from the group Gn formed by the inverters IVn−1 and IVn, the respective second terminals of which are connected together directly to the reference earth.

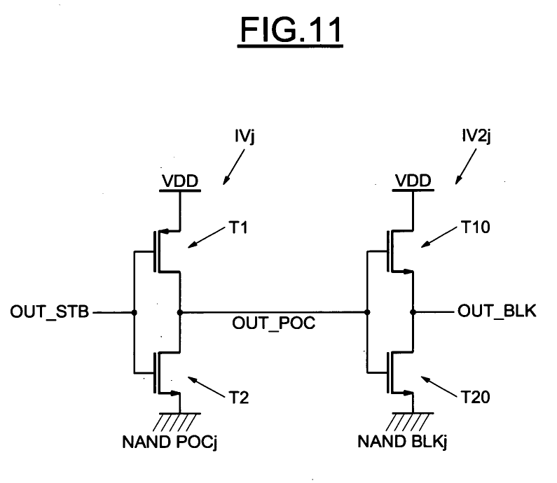

By influencing the mutual offset of the falling edges of the voltages of the columns to be deselected, the invention has made it possible to maintain an acceptable duration for these edges, which is compatible with an acceptable level of electromagnetic emission. As an indication, values for the delays of the order of 20 to 60 nanoseconds between the initiation of the various falling edges make it possible to maintain an acceptable duration for these edges.

Whereas FIG. 5 and FIG. 6 represent only a single inverter IVj for the control block BCCj, and an intermediate block Bj which is generally composed of an inverter and a step-up voltage converter and is connected between the inverter IVj and the power stage BSj, it is also possible to produce each control block, for example the control block BCC1, as illustrated in FIG. 10. More precisely, this FIG. 10 shows the shift register RAD, the latch memory MV and the part of the control block BCC1 which lies upstream of the power stage BS1 and includes in particular two NAND logic gates respectively referenced NAND POC1 and NAND BLK1.

The first logic gate NAND POC1 has a first input capable of receiving a logic signal POC so as to be set to a high logic state, and a second input connected to the corresponding output OUT_STB1 of the latch memory MV. The second logic gate NAND BLK1 has a first input capable of receiving another logic signal BLK so as to be set to a high logic state, and a second input connected to the output OUT_POC of the logic gate NAND POC1. The output OUT_BLK of the gate NAND BLK1 is connected to the power stage BS1, the output OUT1 of which is connected to the column C1.

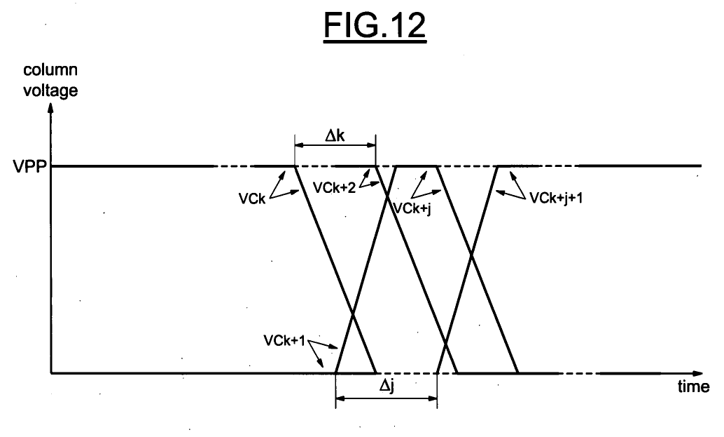

In fact, as illustrated in FIG. 11, the logic gate NAND POCj with its first input set to the high state (signal POC in the high state) is functionally equivalent to the inverter IVj of FIGS. 5 and 6, even though the gate NAND POCj actually includes two inverters. Likewise, even though the gate NAND BLKj includes two inverters, this logic gate with its first input set to the high state (signal BLK in the high state) is functionally equivalent to another inverter, here referred to as the inverter IV2j, formed by the complementary transistors T10 and T20. FIG. 10 also shows the auxiliary resistive network formed by the auxiliary resistors R as illustrated in FIG. 6.

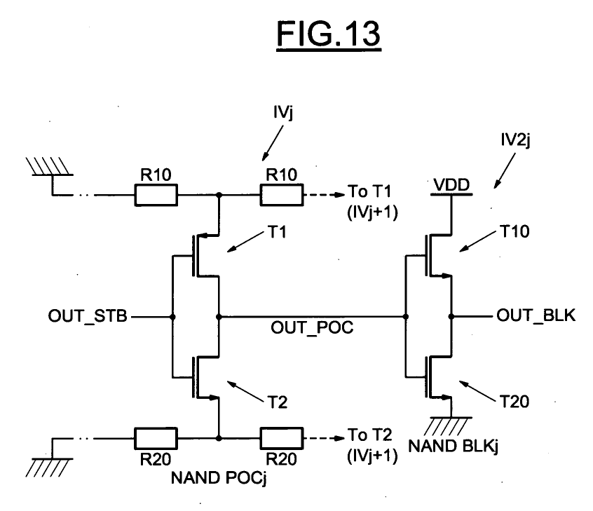

Reference will now be made to FIG. 12 and the subsequent figures to describe embodiments and implementations which allow selections and deselections of columns non-simultaneously. When a previously deselected column is to be selected (to illuminate or extinguish a pixel depending on the mode of use selected for the screen), it is then necessary to bring the column voltage from the value 0 volt to the value VPP, for example. This is done by applying a control logic signal to the individual control block BCC, which in response makes the column voltage rise (this corresponds to charging the capacitance of the cell) and this entails a rising edge which is referred to here as being a column selection signal. Such rising edges are illustrated in FIG. 12 where, for example, column k+1 and column k+j+1 have been selected. The column voltage VCk+1 and the column voltage VCk+j+1 thus have a rising edge.

Columns k, k+2 and k+j have furthermore been deselected in this FIG. 12, for example, as shown by the falling edges of their corresponding column voltages. In the control block BCC, when a previously deselected column is to be selected, a low logic level, for example 0 volt, is applied to the gates of the two transistors T1 and T2 of the first inverter IVj (FIG. 11), the effect of which is to turn on the power transistor of the power stage PSj, which is connected to the supply voltage, and to turn off the other power transistor. The capacitance of the cell therefore charges and the column voltage rises from the value 0 to the value VPP.

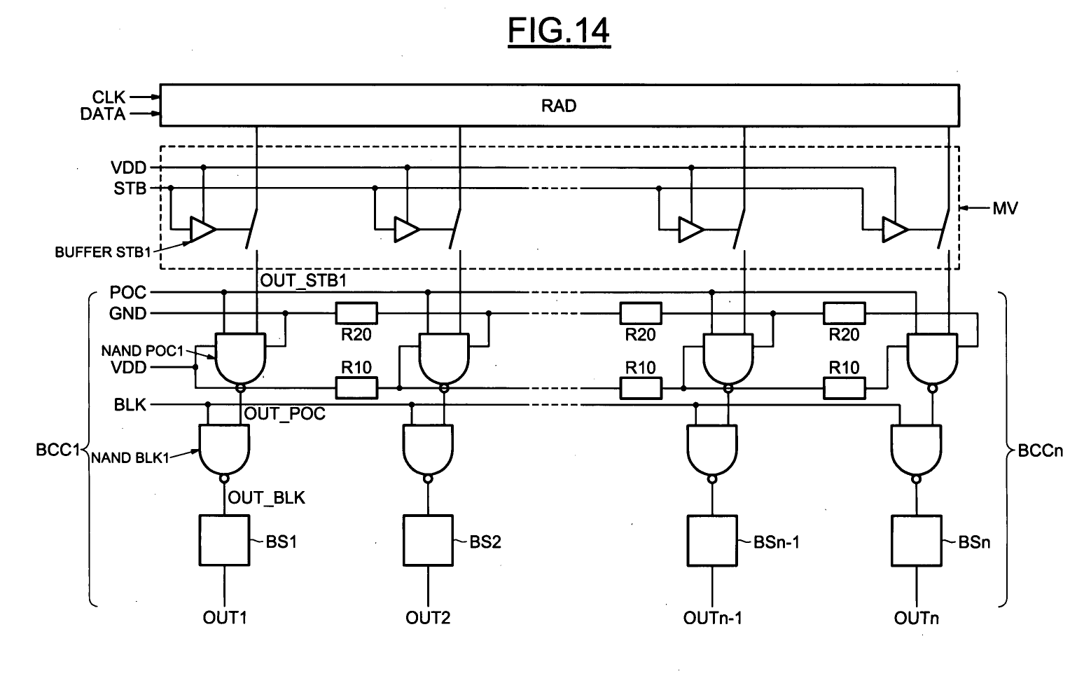

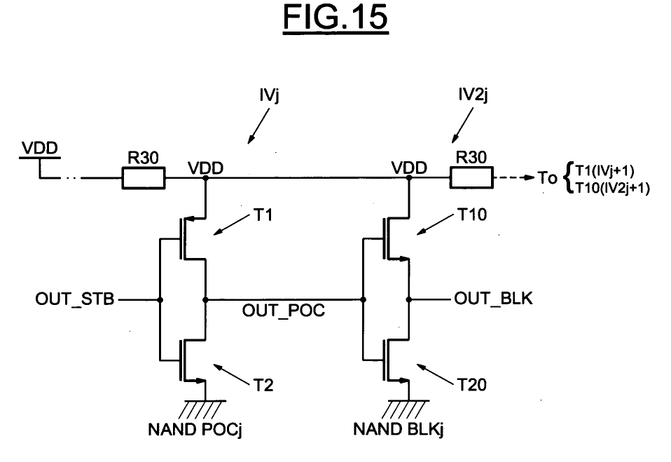

In practice, the deselection control signals and the selection control signals, i.e. the data present at the outputs of the latch memory MV, are delivered simultaneously to the inverters IVj. One way of mutually offsetting the appearance of the falling edges of the column voltages and the rising edges of the column voltages (as illustrated in FIG. 12) consists in using the embodiment illustrated in FIGS. 13 and 14. FIG. 13 shows the auxiliary resistive network, which is formed by resistors R20 and makes it possible to mutually offset the falling edges of the voltages of columns which are to be deselected.

Besides this auxiliary resistive network R20, secondary delay means are provided which include secondary resistors R10 connected in series. The secondary resistive network is connected between the first terminal of the first inverter of a first control block BCCn (FIG. 14) and the supply voltage VDD. Furthermore, the terminals of the various secondary resistors R10 are respectively connected to the first terminals of the inverters IVj of at least some of the individual control blocks BCCj.

The secondary resistive network formed by the resistors R10 thus allows non-simultaneous selection of previously deselected columns. Furthermore, the embodiment of FIG. 13 and/or FIG. 14 consequently makes it possible to select certain previously deselected columns non-simultaneously and to deselect certain other previously selected columns, also non-simultaneously.

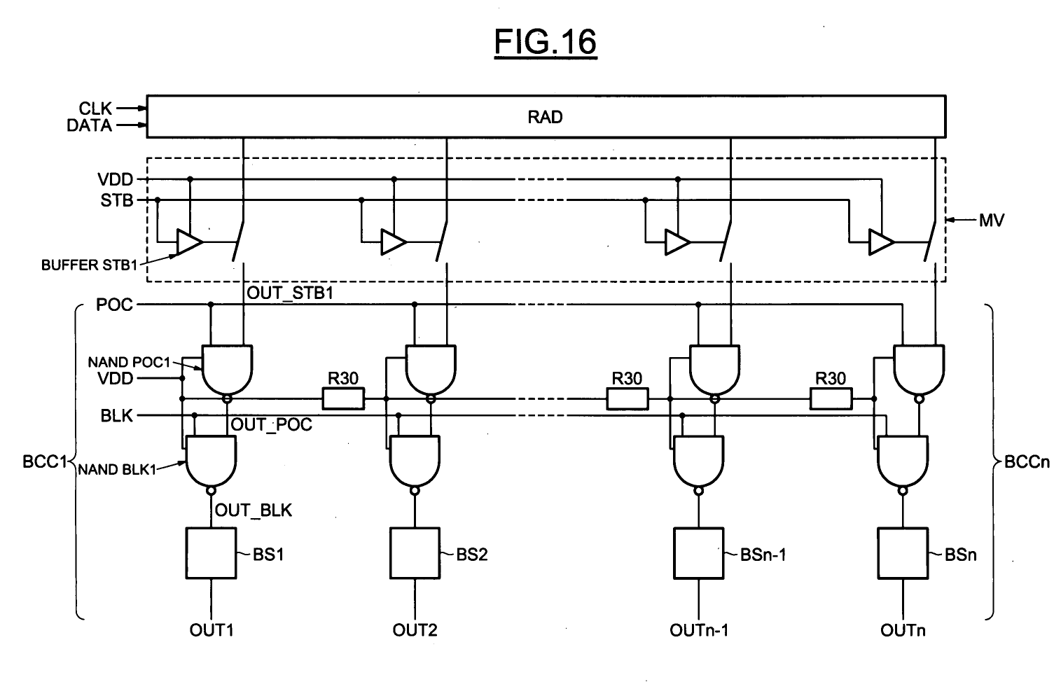

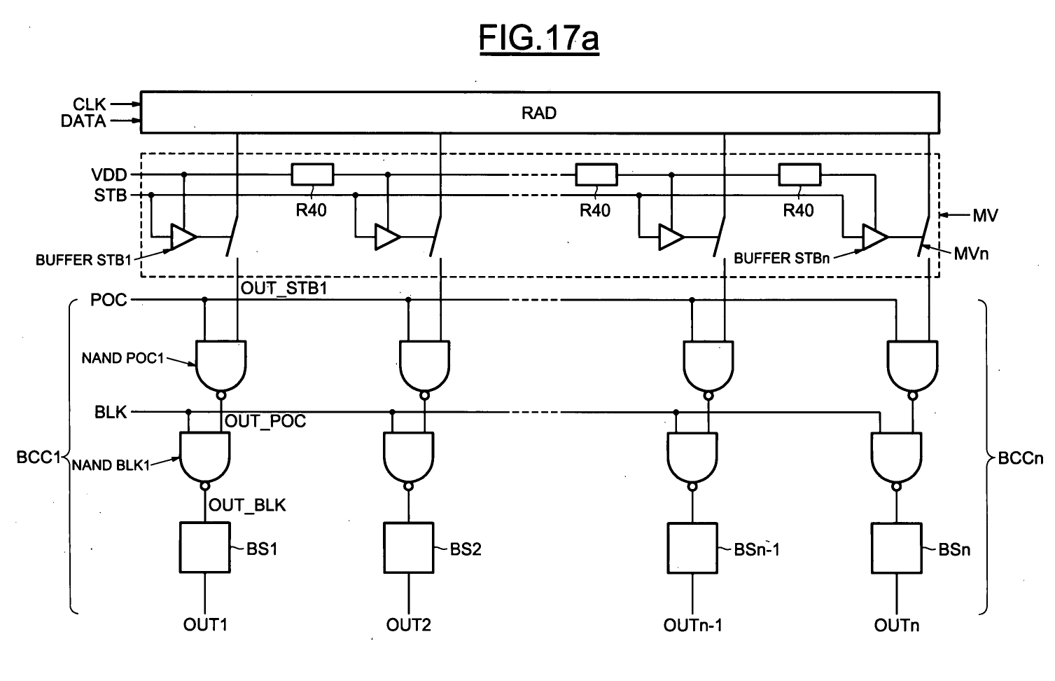

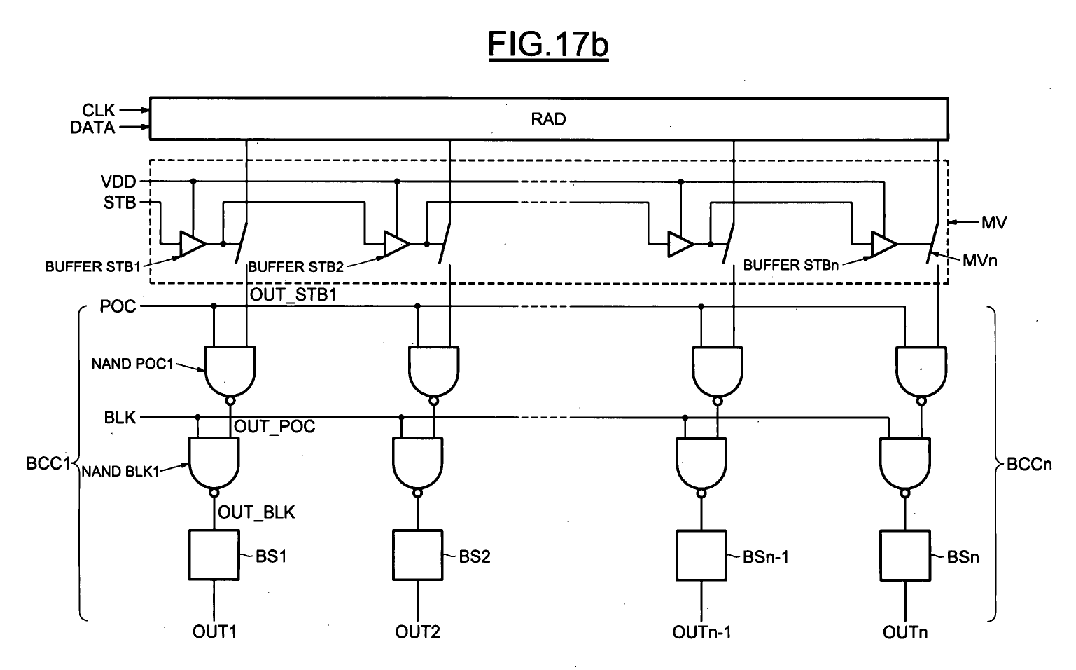

It is particularly preferable for the auxiliary delay means and the secondary delay means to be formed by the same means. This is the case, for example, in the embodiments illustrated in FIGS. 15 and 16, on the one hand, and FIGS. 17A and 17B on the other hand. As regards the embodiment illustrated in FIGS. 15 and 16, this involves the two inverters IVj and IV2j respectively incorporated in the gates NAND POCj and NAND BLKj.

More precisely, each control inverter IVj and IV2j has a first terminal connected to the supply voltage VDD and a second terminal connected to the reference earth. The common means then comprise a common resistive network including common resistors R30 connected in series. The common resistive network is connected between the first terminal of each inverter of a first control block BCCn and the supply voltage. The terminals of the various common resistors R30 are furthermore respectively connected to the first terminals of the two inverters of at least some of the individual control blocks. In this embodiment, the delay on the rising edges is thus generated in the logic gates NAND POC whereas the delay on the falling edges is generated in the logic gates NAND BLK.

In the embodiment of FIG. 17A, the common delay means are arranged at the latch memories MV. More precisely, each latch memory is connected at the input of an individual control block, and more particularly to the input of the logic gate NAND POC which does not receive the signal POC. Amplification means (or buffers) referenced BUFFER STB are furthermore provided, which are all capable of receiving the same input control signal STB and of respectively delivering amplified control signals to control the latch memories respectively. Each amplification means BUFFER STB has a first terminal connected to a supply voltage.

Here, the common resistive network furthermore includes common resistors R40 connected in series. The common resistive network is connected between the first terminal of an amplification means of a first latch memory and the supply voltage, for example the latch memory MV. Furthermore, the terminals of the various common resistors R40 are respectively connected to the first terminals of the amplification means BUFFER STB of at least some of the latch memories. In this embodiment, the delays on the falling and rising edges are generated in the means for amplifying the signal STB. As for the embodiment illustrated in FIG. 16, it is merely necessary to have a single resistor per stage.

In the embodiment of FIG. 17B, the common delay means are also arranged at the latch memories MV. More precisely, here again each latch memory is connected at the input of an individual control block, and more particularly to the input of the logic gate NAND POC which does not receive the signal POC. The amplification means (or buffers) referenced BUFFER STB form a chain here. More precisely, the first amplification means BUFFER STB1 of the chain is capable of receiving the input control signal STB and of delivering as output an amplified control signal which is used as an input control signal for the second amplification means BUFFER STB2 of the chain. Furthermore, the input control signal of a current amplification means starting from the second is the output signal delivered by the previous amplification means. As in the previous embodiment of FIG. 17A, the amplified control signals respectively control the latch memories.

Each amplification means BUFFER STB has a first terminal connected to a supply voltage. The common delay means are formed here by the chain of the amplification means BUFFER STBi, and the delays on the falling and rising edges are generated in the means for amplifying the signal STB.

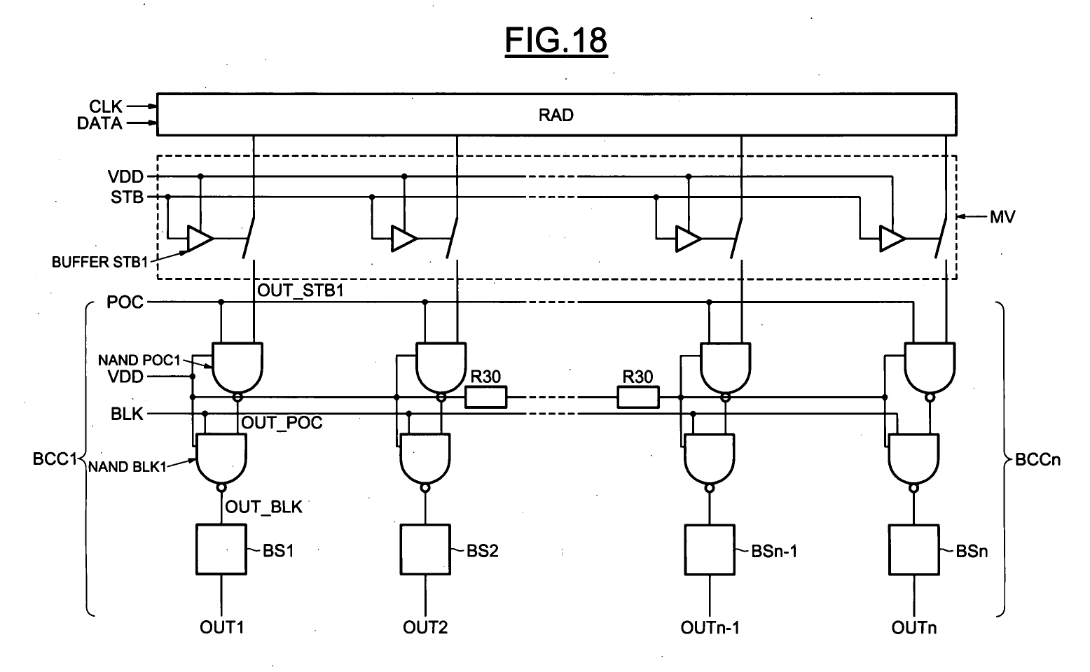

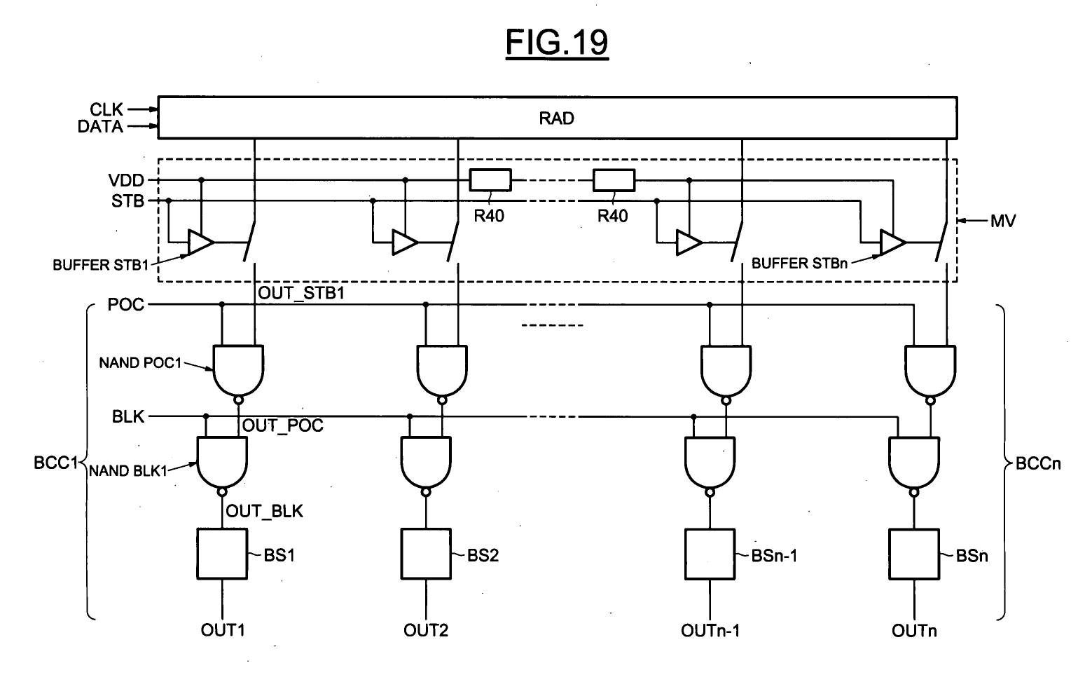

The embodiments illustrated in FIGS. 18 and 19 make it possible to select and deselect the columns by groups of columns, each group including two columns for example in the figures, and each group being selected or deselected at a time different from the deselection or selection time of another group. More precisely, in the embodiment of FIG. 18, the group G1 includes the columns 1 and 2, whereas the group Gn includes the columns n−1 and n. Furthermore, the supply terminals of the two pairs of logic gates NAND POC and NAND BLK of each group are connected together and connected to the two pairs of an adjacent group via a common resistor R30 of the common resistive network.

A similar layout is shown in FIG. 19, but this time in the arrangement of the column control circuit MV. More precisely, the supply terminals of the two amplification means BUFFER STB of a group are connected together and are connected to the two amplification means of an adjacent group via a common resistor R40 of the common resistive network.

The invention is not limited to the embodiments and implementations which have just been described, but encompasses all their variants.

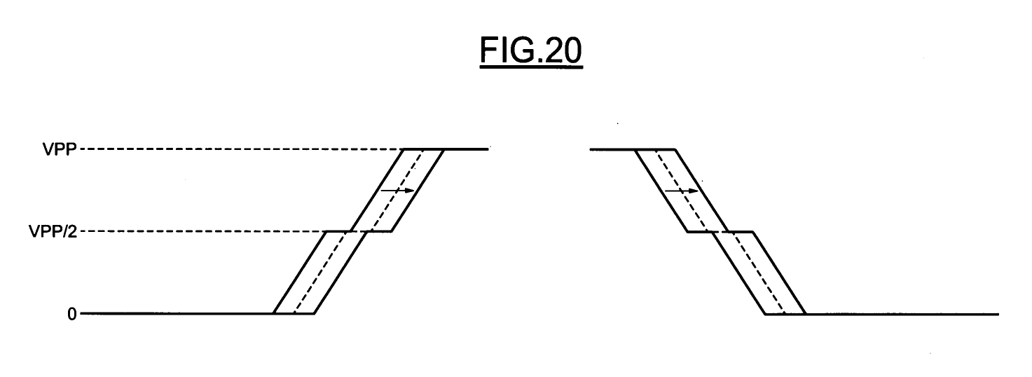

All of the edges, for instance, whether falling or rising, were presented above as transitions from 0 volt to a fixed voltage, or vice versa. It is of course also possible for these transitions to take place in a plurality of steps, for example from zero to VPP/2 then from VPP/2 to VPP, and vice versa, as illustrated in FIG. 20. The left-hand part of this figure represents rising edges which are mutually delayed and produced in two stages, whereas the right-hand part of FIG. 20 represents falling edges which are mutually delayed and likewise produced with two stages.

1-27. (canceled)

28. A method for controlling a plasma matrix screen including a matrix having rows and columns of cells, the method comprising:
sequentially selecting rows of the matrix; and
for a selected row, non-simultaneously deselecting a plurality of columns of the matrix which were previously selected during selection of a previous row.

29. The method according to claim 28, wherein deselecting a previously selected column comprises delivering a deselection signal to the column in response to a deselection control signal, wherein deselecting the previously selected columns includes simultaneous reception of deselection control signals for the previously selected columns and, in response to the simultaneous reception, non-simultaneously delivering at least some of the deselection signals.

30. The method according to claim 29, wherein each of the non-simultaneously delivered deselection signals is respectively delayed.

31. The method according to claim 30, wherein the delays are variable and based upon the number of columns deselected.

32. The method according to claim 28, wherein the previously selected columns are deselected by groups of columns, each group including at least one column and each group being deselected at a time different from the deselection time of another group.

33. The method according to claim 28 further comprising, for a selected row, non-simultaneously selecting a plurality of columns of the matrix which were previously deselected during the selection of a previous row.

34. The method according to claim 33, wherein the previously deselected columns are selected by groups of columns, each group including at least one column and each group being selected at a time different from the selection time of another group.

35. A device for controlling a plasma matrix screen including a matrix having rows and columns of cells, the device comprising:
a row control circuit to sequentially select rows of the matrix; and
a column control circuit to non-simultaneously deselect a plurality of previously selected columns.

36. The device according to claim 35, wherein the column control circuit comprises:
individual control blocks respectively connected to the columns of the matrix, each individual control block receiving a deselection control signal and delivering a deactivation signal to the column in response thereto;
a controller to simultaneously deliver deselection control signals to the individual control blocks of the columns to be deselected; and
an auxiliary unit to cause non-simultaneous delivery of at least some of the deselection signals.

37. The device according to claim 36, wherein the auxiliary unit includes an auxiliary delay unit to respectively delay at least some of the deselection signals.

38. The device according to claim 36, wherein each control block includes a first control inverter having a first terminal connected to a supply voltage and a second terminal; and wherein the auxiliary unit includes an auxiliary resistive network including auxiliary series connected resistors, the auxiliary resistive network being connected between the second terminal of the first inverter of a first control block and a reference voltage, and terminals of various auxiliary resistors being respectively connected to the second terminals of the first inverters of at least some of the individual control blocks.

39. The device according to claim 38, wherein each control block includes a first NAND logic gate having a first input to be set to a high logic state and a second input connected to the controller, the NAND logic gate with first input set to the high logic state being functionally equivalent to the first inverter.

40. The device according to claim 35, wherein the column control circuit deselects the previously selected columns by groups of columns, each group including at least one column and each group being deselected at a time different from the deselection time of another group.

41. The device according to claim 38, wherein the column control circuit deselects the previously selected columns by groups of columns, each group including at least one column and each group being deselected at a time different from the deselection time of another group; and wherein the individual control blocks form a plurality of groups, the second terminals of the first inverters of the individual control blocks of a given group being connected together and connected to the second terminals of the first inverters of the individual control blocks of an adjacent group via an auxiliary resistor of the auxiliary resistive network.

42. The device according to claim 41, wherein the column control circuit also non-simultaneously selects a plurality of previously deselected columns.

43. The device according to claim 42, wherein each individual control block receives a selection control signal and delivers an activation signal to the column in response thereto; and wherein the controller simultaneously delivers selection control signals to the individual control blocks of the columns to be selected; and further comprising a secondary unit to cause non-simultaneous delivery of at least some of the selection signals.

44. The device according to claim 43, wherein the secondary unit includes a secondary delay to respectively delay at least some of the selection signals.

45. The device according to claim 43, wherein the secondary unit includes a secondary resistive network including secondary resistors connected in series, the secondary resistive network being connected between the first terminal of the first inverter of a first control block and the supply voltage, and terminals of various secondary resistors being respectively connected to the first terminals of the first inverters of at least some of the individual control blocks.

46. The device according to claim 43, wherein the secondary unit is defined by the auxiliary unit.

47. The device according to claim 46, wherein each individual control block further includes a second control inverter connected in series with the first control inverter, each first and second control inverter having a first terminal connected to a supply voltage and a second terminal connected to a reference voltage; and wherein the secondary and auxiliary units comprise a common resistive network including common series connected resistors, the common resistive network being connected between the first terminal of each control inverter of a first control block and the supply voltage, and the terminals of various common resistors being respectively connected to the first terminals of the first and second control inverters of at least some of the individual control blocks.

48. The device according to claim 46, wherein the controller of the column control circuit further comprises:
latch memories respectively connected at the input of the individual control blocks; and
amplifiers respectively receiving the input control signal and respectively delivering amplified control signals to respectively control the latch memories, each amplifier having a first terminal connected to a supply voltage;
the secondary and auxiliary units comprise a common resistive network including common series connected resistors, the common resistive network being connected between the first terminal of an amplifier of a first latch memory and the supply voltage, and the terminals of the various common resistors being respectively connected to the first terminals of the amplifiers of at least some of the latch memories.

49. The device according to claim 46, wherein the controller of the column control circuit further comprises:
latch memories respectively connected at the input of the individual control blocks; and
a chain of amplifiers connected in series to respectively receive input control signals and respectively deliver amplified control signals to respectively control the latch memories, the input control signal of a current amplifier is the output signal delivered by a previous amplifier.

50. The device according to claim 48 wherein each control block includes a first NAND logic gate having a first input to be set to a high logic state and a second input connected to the controller, the NAND logic gate with first input set to the high logic state being functionally equivalent to the first inverter; and wherein each control block further includes a second NAND logic gate having a first input to be set to a high logic state and a second input connected to the output of the first NAND logic gate, the second NAND logic gate with first input set to the high logic state being functionally equivalent to the second inverter.

51. The device according to claim 42, wherein the column control circuit selects the previously selected columns by groups of columns, each group including at least one column and each group being deselected at a time different from the deselection time of another group.

52. The device according to claim 50 wherein the column control circuit selects the previously selected columns by groups of columns, each group including at least one column and each group being deselected at a time different from the deselection time of another group; and wherein the individual control blocks form a plurality of groups, the second terminals of the two inverters of the individual control blocks of a given group being connected together and connected to the second terminals of the amplifier of the latch memories of an adjacent group via a common resistor of the common resistive network.

53. The device according to claim 50 wherein the column control circuit selects the previously selected columns by groups of columns, each group including at least one column and each group being deselected at a time different from the deselection time of another group; and wherein the individual control blocks form a plurality of groups, the first terminals of the amplifiers of the latch memories of a given group being connected together and connected to the first terminals of the amplifiers of the latch memories of an adjacent group via a common resistor of the common resistive network.

54. A plasma display screen comprising:
a plasma matrix having rows and columns of cells; and
a control device for controlling the plasma matrix, the device comprising
a row control circuit to sequentially select rows of the matrix, and
a column control circuit to non-simultaneously deselect a plurality of previously selected columns.

55. The plasma display screen according to claim 54, wherein the column control circuit comprises:
individual control blocks respectively connected to the columns of the matrix, each individual control block receiving a deselection control signal and delivering a deactivation signal to the column in response thereto;
a controller to simultaneously deliver deselection control signals to the individual control blocks of the columns to be deselected; and
an auxiliary unit to cause non-simultaneous delivery of at least some of the deselection signals.
